(19) United States
(12) Patent Application Publication
(10) Pub. No.: US 2020/0000132 A1
(43) Pub. Date: Jan. 2, 2020

(54) PROCESSED PORK PRODUCT CONTAINING HIGH CONCENTRATION OF PORK-DERIVED COLLAGEN AND METHOD FOR PREPARING THE SAME

(71) Applicant: Yoo Taek KIM, Seoul (KR)

(72) Inventors: Yoo Taek KIM, Seoul (KR); Yu Ri LEE, Seoul (KR); Yong Seob JEONG, Seoul (KR)

(21) Appl. No.: 16/485,566

(22) PCT Filed: Feb. 13, 2018
(86) PCT No.: PCT/KR2018/001879

§ 371 Date: Aug. 13, 2019

(30) Foreign Application Priority Data
Feb. 13, 2017 (KR) 10-2017-0019678

(51) Int. Cl. A23L 13/30; A23B 4/02; A23L 27/14; A23L 5/10; A23P 30/32; A23J 1/02; A23G 3/40; A23G 3/50

(52) U.S. Cl. CPC A23L 13/30; A23B 4/02; A23L 27/14; A23L 5/15; A23V 2002/00; A23J 1/02; A23G 3/40; A23G 3/50; A23P 30/32

(57) ABSTRACT

Provided is a method for preparing a processed pork snack containing a high concentration of pork-derived collagen by a process, including the following steps: step (1) of washing and cutting of raw material pork); step (2) of pork boiling; step (3) of pork cooling and fat removal; step (4) of cutting according to size, water removal, cutting and preservative addition; step (5) of natural drying, drying at 18 to 30° C.; step (6) of baking at low-temperature drying in an oven; step (7) of boiling; step (8) of natural drying; step (9) of heating and puffing at instantaneous high temperature under pressure; and step (10) of treating the puffed collagen with a carrier such as a sweetener or a preservative.

### CROSS-REFERENCE TO RELATED APPLICATION(S)

This application claims priority to Korean Patent Application No. 10-2017-0019678, filed on Feb. 13, 2017, the disclosure of which is incorporated herein by reference in its entirety.

### BACKGROUND OF THE INVENTION

### Field of the Invention

The present invention relates to a processed pork product containing a high concentration of pork-derived collagen and to a method for preparing the same.

More particularly, the present invention relates to the production of a processed pork product containing a high concentration of pork-derived collagen, in which the processed pork product possesses the beneficial function of collagen without changes even after its preparation and has the ability to restore physical properties, and to a puffed snack composition that suits the preference of the elderly, and a method for preparing the same.

### Description of the Related Art

In Korea, adult diseases and senile diseases have recently increased rapidly due to Westernized eating habits, and have become a great social issue. Particularly, in Korea, population ageing progresses rapidly together with a decline in birth rate. As a result, in Korea, the over-65-year-old population accounted for about 11% of the total population in 2010, and is expected to account for 14.3% (aged society) in 2018 and 20.8% (ultra-aged society in 2026.

This rapid population ageing is becoming a global issue.

As aging progresses, the physiological functions of the tissues and organs of the human body decrease irreversibly, and particularly, body fat weight and muscle mass decrease due to a decrease in physical activity. Among changes in the physical function of elders, factors that greatly influence food intake include masticatory dysfunction, swallowing disorders, impaired digestive absorption, hypogeusia and the like. Particularly, in the case of over-75-year-old people, food intake is greatly influenced by the loss of teeth. Due to problems such as the loss of teeth, the chewing ability is reduced, and thus foods that can be taken are limited and the amount and quality of meals can be reduced. Accordingly, it is considered that the provision of a processed pork product in the form of a snack, obtained by puffing collagen in view of physical properties and nutrients according to the physical properties of elderly people, can help maintain the healthy life of elderly people.

Collagen is a major protein present in all connective tissues, including skin, blood vessels, bone, teeth, muscle and the like, is present as an intracellular matrix in other organs, is the most abundant structural protein present in all animals including humans, and accounts for about 30% of the total protein in mammals. 40% of collagen plays an important role in the construction of skin's epidermal cells, and about 20% is contained in bone and cartilage. In addition, collagen is widely distributed in any body parts, including blood vessels, intestines, teeth, etc. Collagen is obtained mainly from the bone, skin and the like of cattle and pigs, and is widely used in the medical, cosmetic and food fields. Generally, collagen has been frequently used as a raw material for cosmetic products because of its function to promote skin moisturization and elasticity. However, in recent years, studies on the effects of the oral intake of collagen on joints or bone have been reported, and as beauty foods have been of increasing interest, collagen that is a beauty function has received a lot of attention.

However, pork (including pork skin) has fundamental problems due to its characteristic preconception and its peculiar odor and tough tissue. Furthermore, unless pork skin is taken instantly after roasting or the like, the tissue becomes tougher as the temperature decreases, and it becomes hardener as water evaporates therefrom. Such disadvantages limit the use of pork as food.

A typical processed food obtained using pork skin is a pork skin snack which is known to be popular in Southeast Asia and Central and South America areas.

A puffing process is a technology that performs treatment at high temperature within a short time to thereby induce various quality changes, including gelatinization of starch present in food, modification and organization of proteins, inactivation of enzymes that induce lipid oxidation during storage, etc. Although puffing is applied mainly to grains, it may also be applied to pork skin collagen to thereby develop a food material having good eating quality without frying. However, pork skin contains large amounts of collagen and lipids, which limit the use of pork skin as a raw material in a puffing machine. Thus, many considerations arise.

Previous studies on pork and collagen are as follows.

Korean Patent No. 10-0507050 (registered on Aug. 1, 2005; entitled “Method for preparing restructured meat using a pork hind leg”) discloses a method for preparing Tteokgalbi (grilled short rib patties)-type reconstructed meat having a high cohesion force, comprising: adding pork's back fat and spices for ribs (such as Gochujang (red chili paste)) to a pork hind leg used as a raw material meat; mixing; filling the mixture in a packing material; and freezing. In this method, the reconstructed meat comprises 60-80 wt % of a pork hind leg, 5-25 wt % of fat, and 15 wt % of Korean traditional rib spices.

Korean Patent No. 10-0777180 (registered on Nov. 12, 2007; entitled “Method for preparing restructured dried meat slices using pork and beef”) discloses a method of preparing restructured dried meat slices using a mixture of pork and beef. More specifically, it discloses a method for preparing dried meat slices, comprising: separating 80-95 wt % of pork and 5-20 wt % of beef into ground meat and joint meat, followed by mixing; adding spices for dried meat slices to the mixture; filling the spice-added mixture into a mold such as cellulose; and heating and drying.

Korean Patent No. 10-1406103 (registered on Jun. 3, 2014; entitled “Method for preparing sausage containing pork skin collagen”) discloses a method for preparing sausage containing pork skin collagen, comprising: washing pork skin; removing an adipose layer from the pork skin; grinding; adding seasonings (e.g., Gochujang, salt, etc.) to the ground pork skin; aging; vacuum packaging; thermal swelling; adding pork or the like; sterilizing; and solidifying.

However, a technology that provides a collagen-rich, nutty, easy-to-eat snack by developing a processed pork product containing a high concentration of collagen, which has a pork-derived protein content of 90% or more, has not yet been reported.

### PRIOR ART DOCUMENTS

### Patent Documents

(Patent Document 0001) Korean Patent No. 10-0507050 (Aug. 1, 2005)

(Patent Document 0002) Korean Patent No. 10-0777180 (Nov. 12, 2007)

(Patent Document 0003) Korean Patent No. 10-1406103 (Jun. 3, 2014)

### SUMMARY OF THE INVENTION

It is an object of the present invention is intended to develop a processed pork product having a pork-derived protein content of 90% or more and to provide a pop snack which is rich in collagen (nutrient component), nutty, and easy to eat.

To achieve the above object, the present invention provides a high concentration of pork-derived collagen by performing a process comprising the following steps, and prepares a processed pork product containing a high concentration of pork-derived collagen, such as a pop snack, by puffing the pork-derived collagen.

The present invention prepares a high concentration of pork-derived collagen by a process comprising the following steps, and prepares a nutty, easy-to-eat snack by puffing the pork-derived collagen.

Step (1) (preparation of raw material; washing and cutting of raw material pork); step (2) (boiling of the raw material pork; first fat removal from the pork and odor removal from the pork); step (3) (cooling of the pork and second fat removal from the pork); step (4) (cutting according to size; water removal, cutting and preservative addition), step (5) (natural drying; drying at 18 to 30° C.); step (6) (baking; low-temperature drying in an oven); step (7) (boiling; third fat removal and salt removal); step (8) (natural drying; drying and grinding); step (9) (puffing; heating and puffing at instantaneous high temperature under pressure); and step (10) (finished pop snack product). If necessary, a food-acceptable sweetener, preservative or additive is added to the puffed collagen, thereby preparing a snack which is a processed pork product containing a high concentration of pork-derived collagen.

### BRIEF DESCRIPTION OF THE DRAWINGS

FIG. 1 is a flow chart showing a process for preparing a product according to the present invention.

FIG. 2a is a photograph of raw material pork used in step (1) (preparation of raw material: washing and cutting of raw material pork) of the present invention, and FIG. 2b is a photograph of pork segments obtained after performing step (1).

FIG. 3 is a photograph of pork dermis segments obtained after performing step (3) (cooling of pork and fat removal from pork) of the present invention.

FIG. 4 is a photograph of shrunk pork-derived collagen obtained after performing step (6) (baking; low-temperature heating in a rotisserie oven) of the present invention.

FIG. 5 is a photograph of ground collagen obtained after performing step (8) (natural drying and grinding) of the present invention.

FIGS. 6a to 6g are photographs of puffed collagen having various shapes, obtained after performing step (9) (puffing) of the present invention.

FIG. 7 is a photograph showing an example of the formulation obtained in step (10) (finished product) of the present invention.

FIGS. 8a to 8C depict photographs showing the restoration of the product shown in FIG. 6c among the products of step (9) (puffing) of the present invention. Specifically, FIG. 8a is a photograph showing a soaked sample; FIG. 8b is a photograph showing that water was removed from the surface of the sample; and FIG. 8c is a photograph showing the restoration of the sample.

### DESCRIPTION OF SPECIFIC EMBODIMENTS

Hereinafter, the present invention will be described in detail.

Step (1) (Preparation of Raw Material; Washing and Cutting of Raw Material Pork)

Pork belly and loin are cut to a thickness of about 5 cm and about 100 g/segment.

Step (2) (Boiling of Pork; First Fat Removal from Pork and Odor Removal from Pork)

To remove fat formed in the lower layer of the pork segments obtained in step (1), the pork is dipped in boiling water or boiled directly to remove fat, and ginger powder is added to the pork to remove the characteristic odor of the pork.

The process of removing fat may be performed by dipping the pork in boiling water at 100° C. for 2-3 hours or directly boiling the pork at 100° C. for about 2 hours, and removing the floated fat.

Step (3) (Cooling of Pork and Fat Removal from Pork; Second Fat Removal)

The pork obtained in step (2) is naturally removed, the pork epidermis is peeled off using a pincette, and fat is removed from the pork skin byscraping. Namely, the epidermal layer above the dermis and the subcutaneous fat layer below the dermis are removed, and only the pork dermis segments containing a large amount of collagen are taken.

For fat removal, a ladle with a rake may be used.

Step (4) (Cutting According to Size; Water Removal, Cutting and Preservative Addition)

The pork dermis segments obtained in step (3) are cooled, and then water is removed therefrom. Then, in order to facilitate handing and increase the preservative effect, each segment is cut to a square having a size of about 5 cm, and salt as a preservative is added thereto to prevent bacterial contamination.

The preservative salt is added in an amount of 3-4 wt % based on the weight of pork dermis segment. If the preservative is added in an amount of less than 3 wt %, the preservative effect will be insufficient, and if the preservative is added in an amount of more than 4 wt %, the taste will be strong due to an excessive salt content.

Step (5) (Natural Drying)

The pork dermis segments obtained in step (4) are naturally dried to a water content of about 15%. The natural drying may be performed at a temperature of about 18 to 30° C. in a place having good ventilation.

Step (6) (Baking; Low-Temperature Heating in a Rotisserie Oven)

The pork segments dried in step (5) are baked in a rotisserie oven (RONCO ST 5000, Popeil invention LLC, USA) at low temperature to obtain a pork-derived collagen having a water content of 1-2%, a chocolate color and a reduced size of 3 cm×3 cm.

The temperature of the oven is preferably 96 to 98° C., and the baking is performed for about 10-12 hours.

Step (7) (Boiling; Third Fat Removal and Salt Removal)

The collagen obtained in step (6) is swollen in water, and then boiled to finally remove fat. At this time, the content of salt is reduced to ⅓-¼ of the amount of salt added. The temperature of water used for the swelling is 40° C. to 50° C., and the swelling is performed for 20-40 minutes. After swelling, the collagen is boiled at 100° C. for 30-40 minutes.

Step (8) (Natural Drying; Drying and Grinding)

The pure collagen obtained in step (7) is naturally dried to a water content of 12-14%, and then ground using a grinding machine to a particle size of 2-5 mm, which is suitable for puffing.

Herein, the natural drying is preferably performed at room temperature for 6-12 hours.

If the water content in step (7) is lower than 10%, the puffing rate will be about 60%, and if the water content is higher than 15%, the puffing rate will be as low as 30% or below.

Step (9) (Puffing; Heating and Puffing at Instantaneous High Temperature Under Pressure)

The ground collagen obtained in step (8) is placed in a puffing machine in which it is heated and puffed at instantaneous high temperature under pressure, thereby obtaining a puffed pop snack. The puffing is performed at a temperature of 180 to 225° C. under a pressure of 1.5-3 Kgf for 9-11 seconds. If the water content in step (7) is 10-15%, the puffing rate in step (9) is 100%.

Step (10) (Finished Pop Snack Product)

A mixture solution comprising chocolate, a sweetener, an excipient and an additive (vitamin C) is spray-coated on the puffed pop snack obtained in step (9), thereby obtaining a finished pop snack product.

In the present invention, the sweetener may be one or more selected from among sugar, millet jelly, oligosaccharides and honey, and the excipient may be one or more selected from among starch, lactose, and white sugar. The additive may be one or more selected from among BHT, BHA, vitamins and tocopherol.

To prepare formulations other than the snack, one or more food-acceptable carriers selected from among one or more sweeteners, one or more excipients and one or more additives are added to the prepared processed pork product containing a high concentration of pork-derived collagen, thereby obtaining a processed pork product composition containing a high concentration of collagen.

The puffing process of step (9) (puffing) is the most important process among processes for preparation of a pop snack, and may be performed using one of the following methods. Puffing is a technology that performs treatment at high temperature within a short time to thereby induce various quality changes, including gelatinization of starch present in food, modification and organization of proteins, inactivation of enzymes that induce lipid oxidation during storage, etc. Although puffing is applied mainly to grains, it may also be applied to pork rind collagen to thereby develop a food material having good eating quality without frying. However, pork rind contains large amounts of collagen and lipids, which limit the use of pork rind as a raw material in a puffing device. Thus, considerations arise. Accordingly, puffing method (1) includes a method, comprising drying boiled pork, and then frying the pork in sugar oil or polysaccharide oil. However, the puffing rate is about 75-80%, but fat is not completely removed, and oxidation progresses fast due to the correlation between the remaining trans-fat and frying oil, and thus many problems arise when the product is stored without being taken immediately.

Puffing method (2) can puff boiled pork in a microwave oven after drying. In this method, the puffing rate is about 65-75% depending on the drying degree and the water content. This method is not preferable, because the risk of damage to protein exists. Particularly, there is a difference in puffing between the outer portion containing no water and the inner part containing water, and the remaining fat comes out to the outside due to electron waves and is coated on the surface. Thus, 30 minutes after burning of the surface, the product may have a hard texture, and when it is oxidized, it results in a very risky event, such as the generation of a carcinogenic substance from the inner part, upon puffing.

Puffing method (3) includes a method of puffing by an air fryer. In this method, fat is reduced as possible so that there is no damage to collagen, and puffing is maximized by controlling the water content, pressure, temperature and time.

According to the present invention, method (3) of puffing by an air fryer is recommended as the most suitable method.

Hereinafter, the present invention will be described in further detail with reference to examples and experimental examples.

### Example

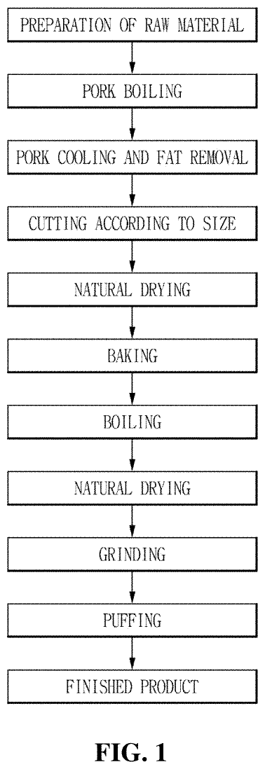

Reference is made to FIG. 1 which is a flow chart showing the overall preparation process of the present invention.

Step (1) (Preparation of Raw Material; Washing and Cutting of Raw Material Pork)

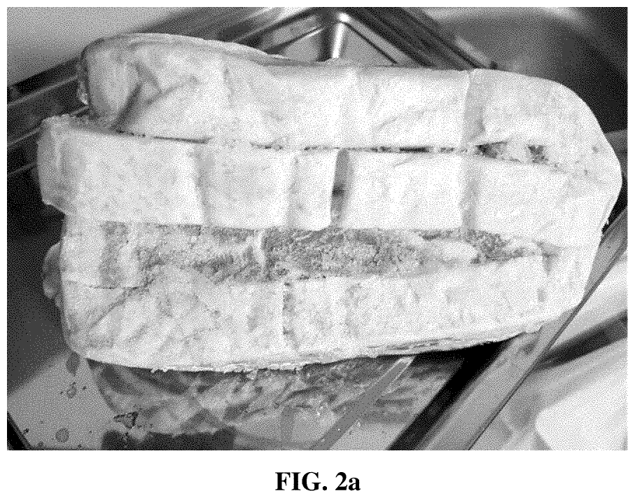

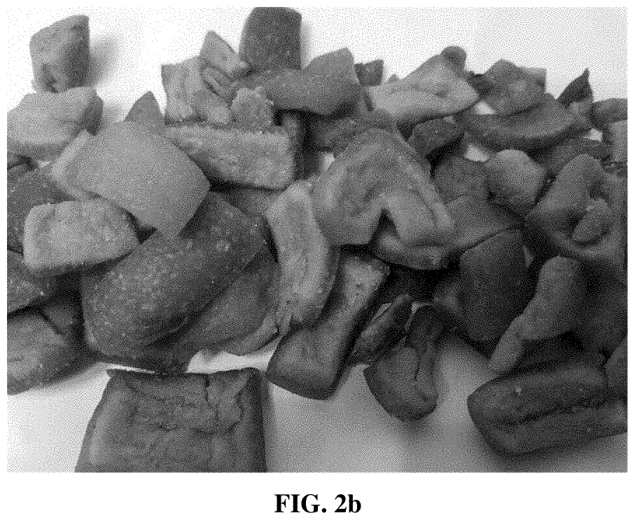

Pork loin and belly (see FIG. 2a) were cut to a size of about 5 cm and about 100 g/segment, and then washed to remove bloody water and porcine hair. Generally, 100 g of pork contains 26.4 g of fat (see FIG. 2b).

Step (2) (Boiling of Pork; First Fat Removal from Pork and Odor Removal from Pork)

To remove fat formed in the lower layer of the pork segments obtained in step (1), the pork was dipped in boiling water at 100° C. for about 2 hours or boiled directly in water at 100° C. for about 2 hours to separate and remove fat. To remove the characteristic odor of the pork, ginger powder was added to the pork in an amount of about 5 wt % based on the pork.

Step (3) (Cooling of Pork and Fat Removal from Pork; Second Fat Removal)

The pork obtained in step (2) was naturally removed, the pork epidermis was peeled off using a pincette, and fat was removed from the pork epidermis by rubbing with a ladle having a rake.

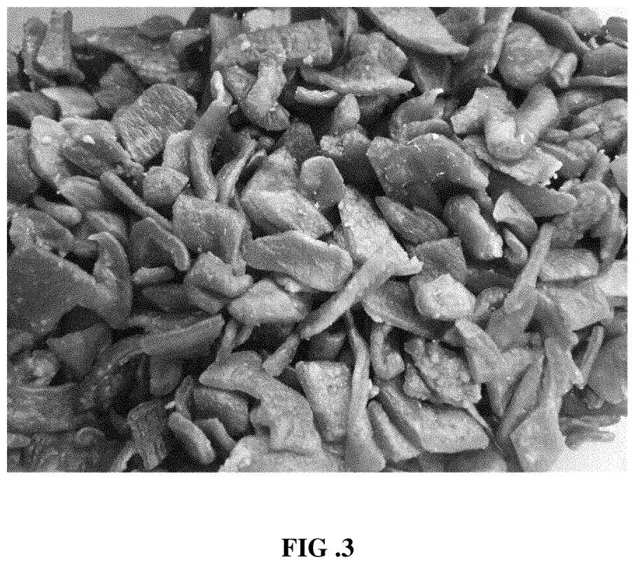

The epidermal layer above the dermis and the subcutaneous fat layer below the dermis were removed, and only the pork dermis segments containing a large amount of collagen were taken (see FIG. 3).

Step (4) (Cutting According to Size; Water Removal, Cutting and Preservative Addition)

The pork dermis segments obtained in step (3) were cooled, and then water was removed therefrom. Then, each segment was cut to a square having a size of about 5 cm, and 3-4 g of salt as a preservative was added thereto to prevent bacterial contamination.

Step (5) (Natural Drying)

The pork dermis segments obtained in step (4) were naturally dried to a water content of about 15% at a temperature of about 18 to 30° C. in a place having good ventilation, while care was taken such that the pork segments are not folded or rolled up.

Step (6) (Baking; Low-Temperature Heating in a Rotisserie Oven)

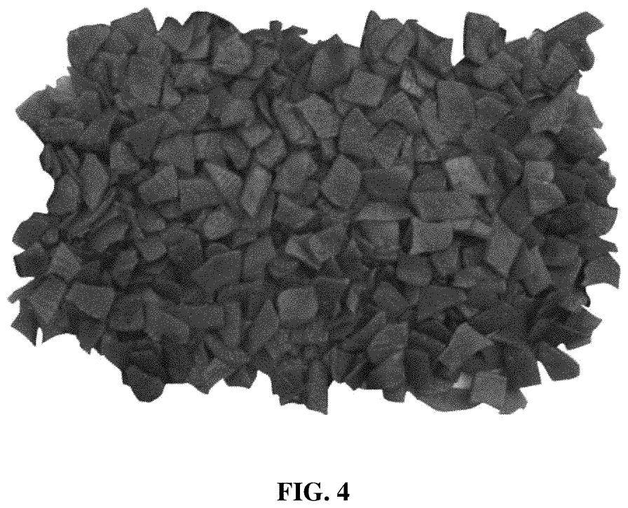

The pork segments dried in step (5) were baked in a rotisserie oven (RONCO ST 5000, Popeil invention LLC, USA) at low temperature to obtain a pork-derived collagen having a water content of 1-2%, a chocolate color and a reduced size of 3 cm×3 cm (see FIG. 4).

Step (7) (Boiling; Third Fat Removal and Salt Removal)

The collagen obtained in step (6) was swollen in water at 50° C. for 20-40 minutes, and then boiled in a capped container at 100° C. for 30-40 minutes to finally remove fat. Herein, the content of salt was reduced to less than 1 g.

Step (8) (Natural Drying; Drying and Grinding)

The pure collagen obtained in step (7) was dried to a water content of 12-14% at room temperature for 6-12 hours, and then ground to a particle size of 2-5 mm by use of a grinding machine (see FIG. 5).

Step (9) (Puffing; Heating and Puffing at Instantaneous High Temperature Under Pressure)

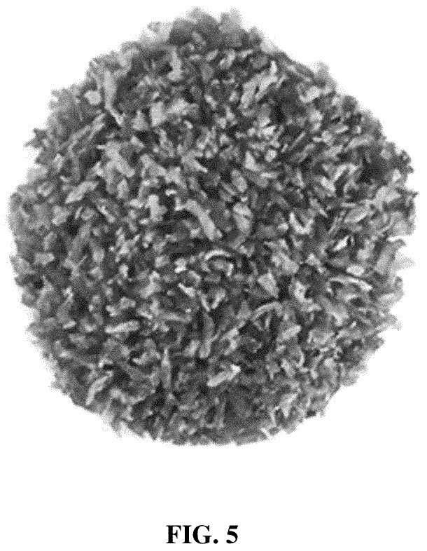

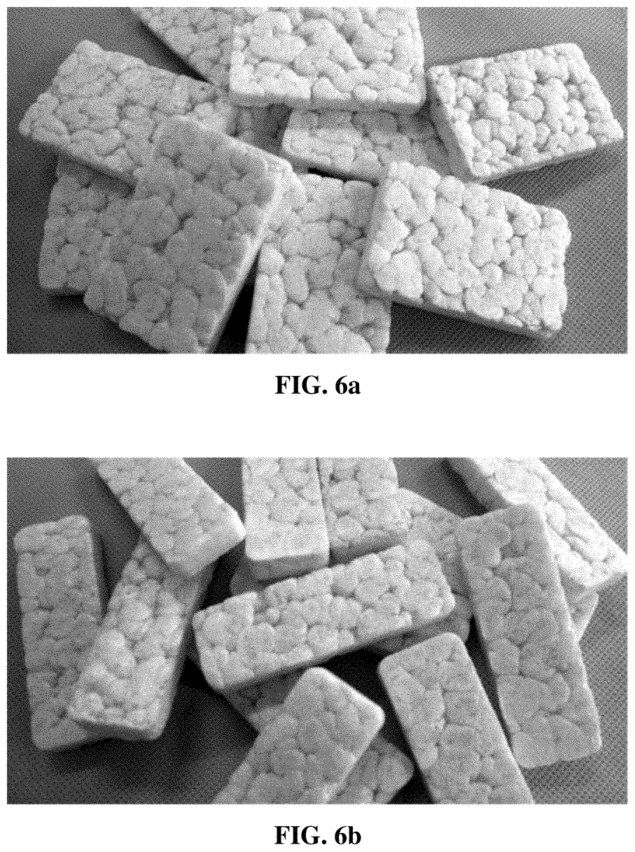

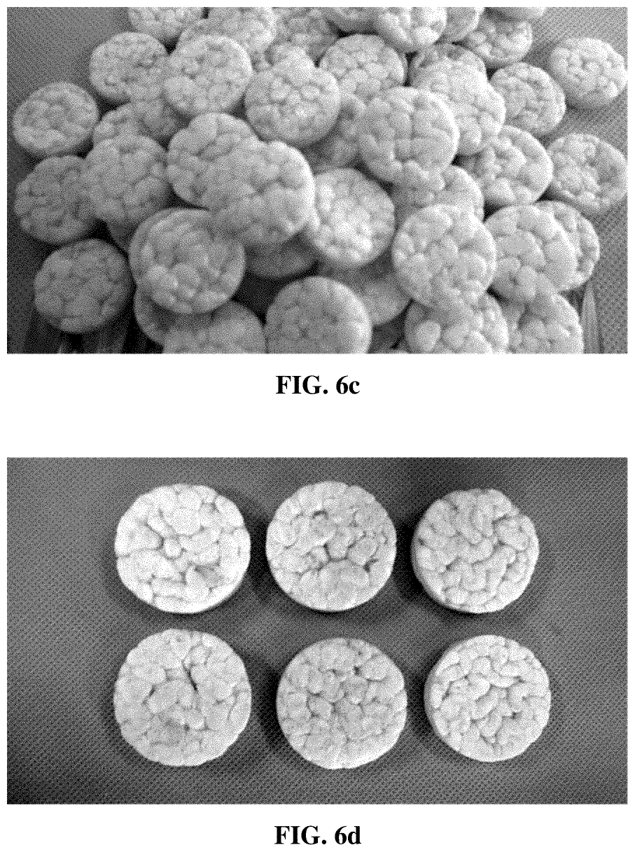

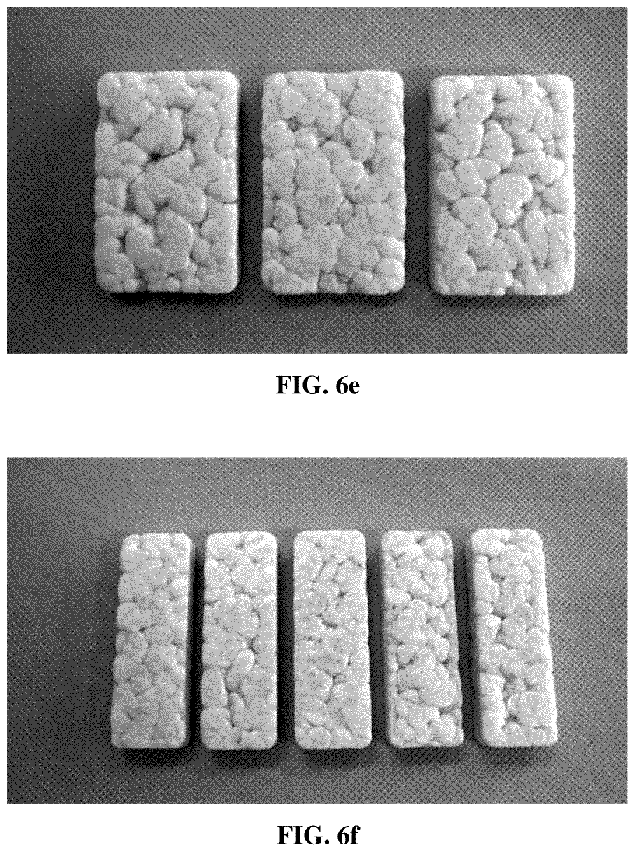

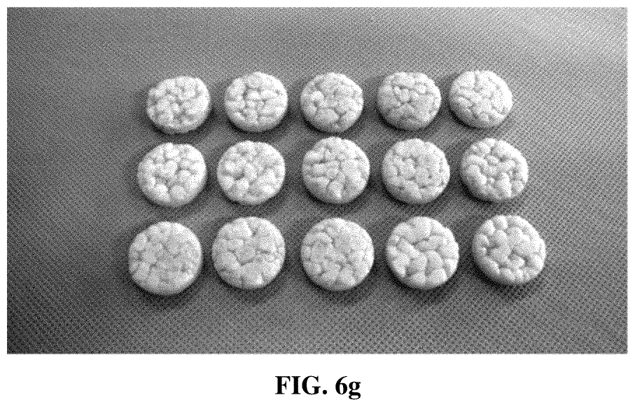

1 g of the collagen obtained in step (8) was placed in a puffing machine (Green Rop, Dae San F&C Co., Korea) in which it was puffed at a temperature of 180 to 225° C. under a pressure of 1.5-3 Kgf for 9-11 seconds. For puffing, a mold for the puffing machine may be manufactured to have various shapes (see FIGS. 6a to 6g).

At this time, the remaining fat was removed, and the weight of the collagen pop product was reduced by about 30% on the average. The puffed collagen was shrunk depending on the water content, temperature and pressure conditions, was crispy in taste, did melt in the mouth, and had a soft taste.

10) Step (10) (Finished Pop Snack Product)

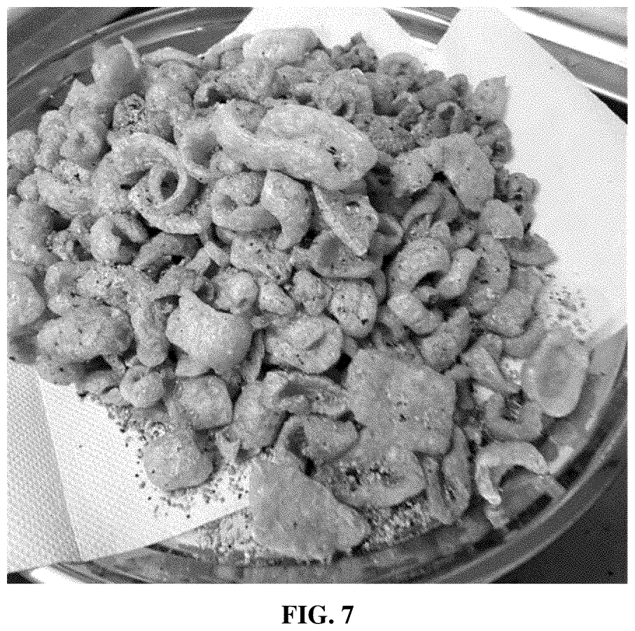

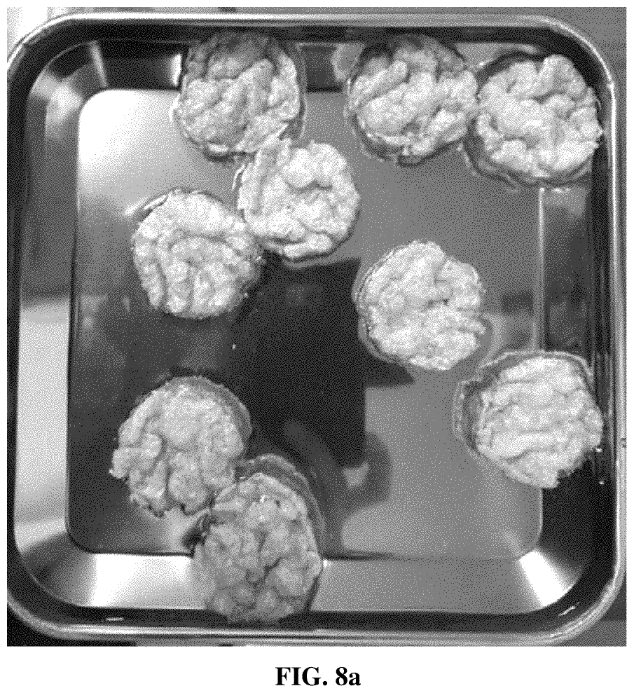

A mixture solution of chocolate (dissolved at 47 to 49° C.) and an additive, which is a mixture of 15% white sugar, 82% cocoa and 3% vitamin C, was spray-coated on the puffed collagen (obtained in step (9)) at a temperature of 27.5 to 28.5° C., thereby obtaining a finished pop snack product (see FIG. 7).

### Other Preparation Examples

1) Preparation of Korean Traditional Confectionery Using Pork (Pork Skin)

Korean traditional confectionery was prepared by coating grain syrup and millet jelly on the puffed pork (pork skin) obtained in step (8) and then attaching a topping material thereto.

As described in the Example above, Korean traditional confectionery was prepared by the steps of: puffing pork (pork skin); coating the puffed material with syrup, followed by coating with a material comprising sesame or the like; and drying and cooling the coated material at room temperature.

To increase the eating quality of the puffed product, a syrup (65-85 Brix) obtained by heating and dissolving one or more selected from among sugar, millet jelly, oligosaccharides, honey and the like was coated on the product in an amount of 50-100 wt %, and then one or more selected from among sesame, black sesame, crisp rice, millet, Indian millet, nut grits, dried blueberry, and dried fruits, was added to the syrup-coated product in an amount of 10-25 wt % based on the weight of the syrup-coated product. To maintain the crispy taste and prevent the products from sticking to each other, the product was naturally dried, thereby obtaining Korean traditional confectionery.

2) Preparation of Energy Bar Using Pork (Pork Skin) Collagen

An energy bar was prepared by the steps of: puffing pork (pork skin) collagen to prepare puffed pork (pork skin) collagen; grinding the puffed pork (pork skin) collagen to prepare puffed collagen flakes; adding sugar to the puffed pork (pork skin) collagen flakes to prepare a dough; and shaping the dough.

In preparation of the energy bar, the puffed pork (pork skin) collagen is preferably ground to a particle size of 0.5-3 cm. The sugar used may be one or a mixture of two or more selected from among honey, millet jelly, sugar and oligosaccharides. The dough may further comprise, in addition to the ground pork (pork skin) collagen, any one or a mixture of two more selected from sub-materials. Herein, the sub-material may be one or more selected from among pumpkin powder, walnuts, pine-nuts, almond, pumpkin seeds, cashew nuts, peanuts, beans, barley leaf powder, sesame, raisins, dried apricots, dried cranberry, dried blueberry, dried plums, dried figs, dried apples, and coconut powder. Generally, any sub-materials that are used in energy bars, cereals, confectionery and meal replacement may be used. Using 50-70 wt % of puffed pork (pork skin) collagen, 27-47 wt % of sugars (grain syrup:millet jelly=4:1), 2 wt % of dried cranberry or other sub-materials, and 1 wt % of pumpkin powder, the pork (pork skin) collagen energy bar was prepared.

### Experimental Example 1

The components of the product obtained in each step of the present invention analyzed and compared, and the results are shown in Table 1 below.

As shown in Table 1, the contents of water, protein, fat and ash in the pork skin resulting from step (3) were 5.08%, 59.03%, 32.44% and 3.41%, respectively, which are similar to the values reported for boiled white pork skin. The pork skin resulting from step (6) is one subjected to the steps of cutting, drying and baking at low temperature for 12 hours, and it was shown that the fat content was significantly reduced through such steps. The fat content after step (3) was 32.44%, and the fat content after step (6) was 9.77%, which corresponds to a decrease in fat content of about 70%. At this time, as the fat content decreased, the protein content increased from 59.03% to 79.95%.

The pork skin processed up to step (6) was boiled, dried, ground, and finally, puffed, thereby obtaining a final product. The protein content of the pork skin resulting from step (9) was as high as 94.32-96.06%. Through the 9-step process, the remaining fat and impurities were removed, and thus the fat content decreased from 9.77% to 1.61-3.35%, and the ash content decreased from 4.54% to 1.30%. Accordingly, through this 9-step process, a snack having a high protein content and a low fat content could be prepared.

TABLE 1

| Test items | After step (3) | After step (6) | After step (9) |
|---|---|---|---|
| Carbohydrate (%) | 0.01 | 0.06 | 0.01% |
| Crude protein (%) | 59.03 | 79.95 | 94.32-96.06% |
| Crude fat (%) | 32.44 | 9.77 | 1.61-3.35% |
| Water (%) | 5.08 | 5.68 | 1.02% |
| Ash (%) | 3.44 | 4.54 | 1.30% |
| Sodium (mg/kg) | — | 1412.27 | 1039.87 |
| ¤ Calorie | — | 429.74 | 433.00 |
| (Kcal/100 | | | |
| g) | | | |

Note:
1. Experimental analysis was performed by Korea Health Supplement Association Sub.. Korea Health Supplement Institute.
2. Each value is the average of three measurements.

### Experimental Example 2: Restoration of Puffed Product

Studies on food restoration have conducted on dried vegetables, beans and grains. Studies on factors that influence the restoration speed of black beans reported that restoration speed was reduced when sugar and salt were added to a soaking solution. In addition, it was reported that the restoration rate in the water adsorption characteristics of powder bean curd was the highest in freeze-dried powder and the lowest in hot-air-dried powder and that in the case of the hot-air-dried product, a long time was required for restoration, because the shape or the cell tissue were completely modified.

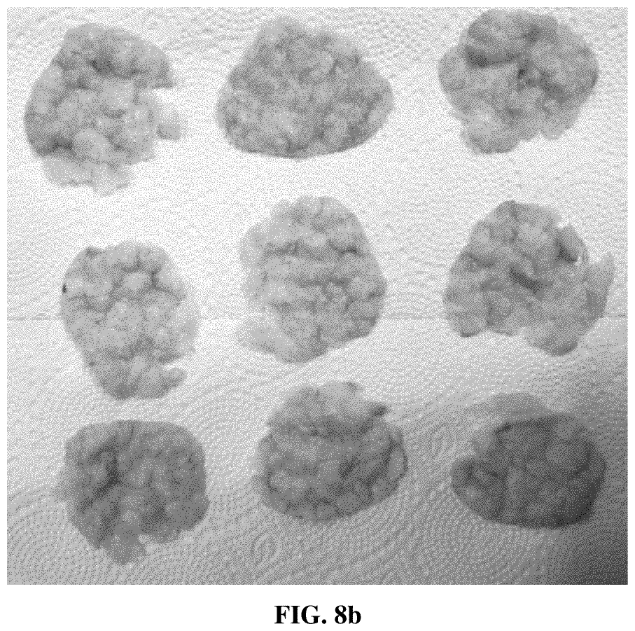

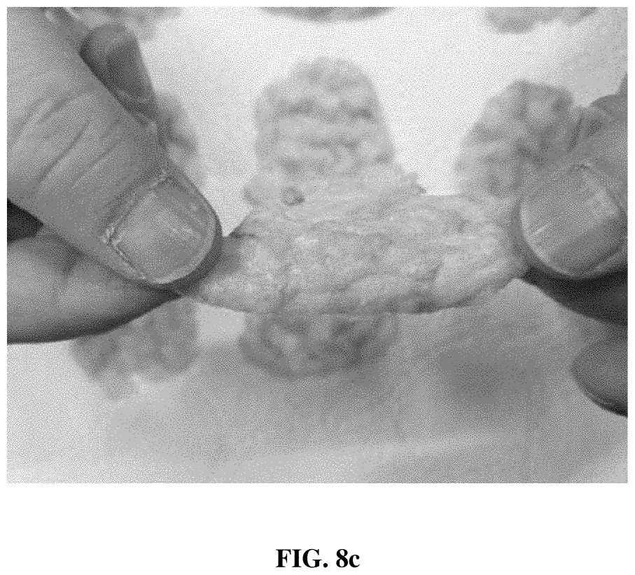

The puffed pork (pork skin) product of the present invention has been developed in the form of a crispy snack (see FIGS. 6a to 6g). To examine the restoration of the pork pop snack, a temperature-controllable constant-temperature water chamber (model SX-10R, Taitec Co., Tokyo, Japan) was used at a temperature of 30° C., and a sample (product shown in FIG. 6c) was placed in a metal container containing distilled water and soaked in the distilled water for 1-2 minutes (see FIG. 8a), and water on the surface of the sample was lightly wiped out with kitchen towel (see FIG. 8b), and the restoration of the sample was photographed (see FIG. 8c). After soaking in distilled water for a certain time, the pop snack retained the properties of pork skin that is a protein clump. The resilience of the pork pop snack could be confirmed by pulling it with both hands. Regarding the eating quality of the pork pop snack, it had chewiness in sensory evaluation.

### Experimental Example 3: Evaluation of Stability

The time-dependent changes (water content, oxidation rate, etc.) of the punished pop snack product of the present invention were examined. As a result, it could be seen that the punished pop snack product could be stored for 12 months or more at room temperature.

### Experimental Example 4: Sensory Evaluation

Sensory evaluation of each of the puffed product after step (9) of the present invention and the fried product after step (9) was performed in the following manner.

Method for Sensory Evaluation

Color, taste, flavor, texture and overall acceptability were evaluated by 10 sensory panelists on a 9-point scale (1=very poor, 9=very good).

Results of Sensory Evaluation

The results of sensory evaluation of the fried product and the puffed product are shown in Table 2 below. As can be seen in Table 2, color and texture did not differ between the two products, but taste, flavor and overall acceptability were higher in the puffed product than in the fried product. In the case of the fried product, the inherent odor of pork caused rejection, and for this reason, the flavor was scored low. The taste of the fried product was scored low, because it was not treated with an additive or the like and retained the peculiar taste of pork. However, the puffed product showed higher scores in terms of taste, flavor and overall acceptability than the fried product, because the odor and taste of pork were improved through several processes in the case of the puffed product. Furthermore, the two products were light yellow in color, and thus showed high color preference. Regarding texture, the two products showed excellent crispness, and thus were evaluated as good snacks.

TABLE 2

| Sample | | | | | Overall |
|---|---|---|---|---|---|
| name | Color | Taste | Flavor | Texture | acceptability |
| Fried | 8.00 ± 0.89 | 3.67 ± 0.82 | 2.50 ± 1.22 | 8.33 ± 0.52 | 3.33 ± 1.03 |
| product | | | | | |
| Puffed | 8.17 ± 0.75 | 7.83 ± 0.75 | 6.00 ± 0.63 | 8.50 ± 0.55 | 8.67 ± 0.52 |
| product | | | | | |

As described above, according to the present invention, a processed pork product containing a high concentration of pork-derived collagen can be prepared, and a nutty and tasty pop snack can be obtained by puffing the processed pork product. In addition, the processed pork product is a stable product that does not deteriorate for 1 year or more, is a functional health food, and is also a diet food having a well-being effect.

1. A processed pork product containing a high concentration of collagen, comprising the following components and contents:

| Components | Contents |
|---|---|
| Calorie (Kcal/100 g) | 433.00 Kcal/100 g |
| Carbohydrate (%) | 0.01% |
| Crude protein (%) | 94.32-96.06% |
| Crude fat (%) | 1.61-3.35% |
| Water (%) | 1.02% |
| Ash (%) | 1.30% |
| Sodium (mg/100 g) | 1039.87 mg/100 g |

2. A method for preparing a processed pork product containing a high concentration of a pork-derived collagen comprising the following components and contents, the method comprising the following steps:
step (1) (preparation of raw material; washing and cutting of raw material pork), in which pork belly and loin are cut to a thickness of 5 cm and 100 g/segment;
step (2) (pork boiling; first fat removal from pork and odor removal from pork), in which pork segments obtained in step (1) are dipped in boiling water or boiled directly to remove fat formed in a lower layer of the pork segments, and ginger powder is added to the pork segments to remove an inherent odor of the pork;
step (3) (pork cooling and second fat removal; second fat removal), in which the pork obtained in step (2) is naturally cooled, the pork epidermis is peeled off using a pincette, and fat is removed from the pork epidermis by Scraping;
step (4) (cutting according to size; water removal, cutting and preservative addition), in which the pork dermis segments obtained in step (3) are cooled, and then water is removed therefrom, after which each segment is cut to a square having a size of about 5 cm, and salt as a preservative is added thereto to prevent bacterial contamination;
step (5) (natural drying), in which the pork dermis segments obtained in step (4) are naturally dried to a water content of about 15%;
step (6) (baking; low-temperature heating in a rotisserie oven), in which the pork segments dried in step (5) are baked in a rotisserie oven (RONCO ST 5000, Popeil invention LLC, USA) at low temperature to obtain a pork-derived collagen having a water content of 1-2%, a chocolate color and a reduced size of 3 cm×3 cm;
step (7) (boiling; third fat removal and salt removal), in which the collagen obtained in step (6) is swollen in water, and then boiled to finally remove fat;
step (8) (natural drying; drying and grinding), in which the pure collagen obtained in step (7) is naturally dried to a water content of 12-14%, and then ground to a particle size of 2-5 mm by use of a grinding machine;
step (9) (puffing; heating and puffing at instantaneous high temperature under pressure), in which the ground collagen obtained in step (8) is placed in a puffing machine in which it is heated and puffed at instantaneous high temperature under pressure, thereby obtaining a processed pork product containing a high concentration of puffed collagen,
the processed pork product comprising the following components and components:

| Components | Contents |
|---|---|
| Calorie (Kcal/100 g) | 433.00 Kcal/100 g |
| Carbohydrate (%) | 0.01% |
| Crude protein (%) | 94.32-96.06% |
| Crude fat (%) | 1.61-3.35% |
| Water (%) | 1.02% |
| Ash (%) | 1.30% |
| Sodium (mg/100 g) | 1039.87 mg/100 g |

3. The method of claim 2, wherein the boiling of pork in step (2) comprises removing fat by dipping the pork segments in a boiling water at 100° C. for 2-3 hours or boiling the pork segments at 100° C. for 2-3 hours.

4. The method of claim 2, wherein the ginger powder in step (2) is added in an amount of 5 wt % based on the weight of the pork.

5. The method of claim 2, wherein the natural drying of the pork segments in step (5) is performed at a temperature of 18 to 30° C. in a place having good ventilation.

6. The method of claim 2, wherein the low temperature of the rotisserie oven in step (6) is 96 to 98° C., and the baking is performed by heating for 10-12 hours.

7. The method of claim 2, wherein the swelling in step (7) is performed in water at 50° C. for 20-40 minutes, and the boiling in step (7) is performed at 100° C. for 30-40 minutes to remove fat.

8. The method of claim 2, wherein the natural drying in step (8) is performed at room temperature for 6-12 hours.

9. The method of claim 2, wherein the puffing in step (9) is performed at a temperature of 180 to 225° C. under a pressure of 1.5-3 kgf for 9-11 seconds.

10. A processed pork product composition containing a high concentration of pork-derived collagen, the composition comprising: a processed pork product containing a high concentration of collagen, defined in claim 1, or a processed pork product containing a high concentration of pork-derived collagen, prepared according to claim 2; and at least one food-acceptable carrier selected from among at least one sweetener, at least one excipient and at least one additive.

11. The processed pork product composition of claim 10, wherein the sweetener is at least one selected from among sugar, millet jelly, oligosaccharides, and honey.

12. The processed pork product composition of claim 10, wherein the excipient is at least one selected from among starch, lactose, and white sugar.

13. The processed pork product composition of claim 10, wherein the additive is at least one selected from among BHT, BHA, vitamin C, and tocopherol.

14. The processed pork product composition of claim 10, further comprising at least one fruit powder selected from among apple powder, almond slices, and pineapple powder, or at least one nut selected from peanut powder, walnut powder, rice powder, linseed, pumpkin seeds, sesame, and Perilla japonica.

15. The processed pork product composition of claim 10, wherein a formulation of the composition is a pop snack, confectionery, Korean traditional confectionery, an energy bar, a pellet, a tablet, powder, or a capsule.

16. The haptic feedback fabric of claim 11, wherein each of the spacer fiber and a fixing fiber is made of a non-conductive material.
